(19) United States
(12) Patent Application Publication
(10) Pub. No.: US 2019/0156251 A1
(43) Pub. Date: May 23, 2019

(54) Movie Matching System and Method(s) of Use

(71) Applicant: Charles E. Watkins, Englewood, CO (US)

(72) Inventor: Charles E. Watkins, Englewood, CO (US)

(21) Appl. No.: 16/196,433

(22) Filed: Nov. 20, 2018

Related U.S. Application Data
(60) Provisional application No. 62/589,045, filed on Nov. 21, 2017.

(51) Int. Cl. G06Q 10/02; G06Q 30/06; G06F 16/78

(52) U.S. Cl. CPC G06Q 10/025; G06F 16/7867; G06Q 30/0627

(57) ABSTRACT

A movie matching system and method(s) of use are described. Embodiments of the movie matching system can include an application on a user device configured to present pairs of movies to a user based on proximity of start times of two movies. Data related to pairs of movies being matched from a plurality of users can be stored in a database. Typically, the data can be stored when a user follows a link to purchase tickets for paired movies in the application.

### CROSS-REFERENCE TO RELATED APPLICATION

This application claims the benefit of U.S. Provisional Application No. 62/589,045 filed Nov. 21, 2017.

### BACKGROUND

Currently, consumers purchase tickets to movies on the internet via one or more third party vendors or at a movie theater. Often times, when families are going to the movies, children and adults want to see different movies. Similarly, groups of friends who want to include a movie in their evening's entertainment may also want to see different movies. As such, consumers must find movies that show at similar times.

There is currently no easy way to ascertain what choices are available for movies nearby which will end at a similar time, or match beginning and ending times so that friends or families can conveniently see different movies. Without that convenience, families or groups of friends often drop the idea of seeing a movie. Further, movie theaters and movie production companies do not consider movie length, movie trailers, nor line-up offerings with the thought that some families and groups of friends could be enticed into choosing a pair of movies if that pair of movies ended or began at the same time.

Generally, movie theater companies offer tickets on a single movie basis. As a consequence, movie theaters and production companies miss out on additive revenue which would exist if potential movie-goers had a quick, convenient method for seeing what choices they had for pairs of movies. Moreover, movie production companies and theaters could cycle the data from movie-goer pairing choices to make effective paired-movie advertising, identical paired movie lengths, and movie line-up choices.

As such, there is a need for an application that can present paired movies having similar start times and/or end times to a consumer while also storing and using data related to which pairs of movies users typically wanted to pair.

### BRIEF DESCRIPTION OF THE DRAWINGS

FIG. 1 is a block diagram of a movie matching system according to one embodiment of the present invention.

FIG. 2 is a block diagram of a movie matching system according to one embodiment of the present invention.

FIG. 3A is a detailed diagram of a user interface of a movie matching application according to one embodiment of the present invention.

FIG. 3B is a detailed diagram of a user interface of a movie matching application according to one embodiment of the present invention.

### DETAILED DESCRIPTION

Embodiments of the present invention include a movie matching system and method(s) of use. The system and method can be implemented to allow a user to find two or more movies that have a start time and/or end time that may be within a predetermined range selected by the user. Other parameters can be included to further refine a listing of movies found by the system. For example, the user may elect to find all movies within a prescribed geographical range whether or not they are at the same movie theater. Typically, the system can include, but is not limited to, a server, one or more user devices, and one or more movie databases. The one or more movie databases can typically include an API service that the server or user devices can call for information related to movie showtimes.

In one embodiment, the one or more user devices can be implemented as the server. For instance, the user devices can include an application or program configured to call and to receive data from the one or more movie databases.

The server and/or the one or more user devices may include an application adapted to (i) call an API to a movie information database, (ii) receive data from the movie database(s), (iii) analyze the data to determine one or more movies having a start time and/or end time within a defined range of time to a movie selected by a user, and (iv) present a list of movies meeting criteria selected by the user.

In one embodiment, the application can be implemented to match two movies in a theater or theaters by proximity of beginning and/or ending times of said movies. In one example, a family (or group of friends) may not agree on viewing a single movie. The application can be implemented to search local movie theaters for two movies with beginning and ending times that are close in time to each other. The search can include a single theater or all theaters near a location defined by the user. In one instance, the search can begin with a single movie selected by the user(s) and the application can search only for matches proximate in time to the selected movie. In another instance, the search can be for both a selected movie and a selected theater.

The application may call one or more API services for movie information and receive data related to, but not limited to, movie length, rating, reviews, theaters, and showtimes. The application may receive the data and use that data to find one or more matching movies based on a user's desired parameters. For example, the user may select to find movies only in a single theater or the user may select matching times with a particular movie. Typically, the application may present the user with the best movie matches based on proximity of time. In one embodiment, the application may present how start times and end times differ between each matched movie (e.g., “This movie begins 10 minutes before ‘Selected Movie’ and ends 10 minutes after ‘Selected Movie’”).

Described hereinafter is one example implementation of the previously described system and method.

First, a user may select a movie they wish to see in the application. Using Gracenote, International Showtimes, or a similar API, the application may pull information related to that movie and all movies being shown in theaters located within a predefined distance of an area where the user is. Alternatively, the user can simply choose to “Pair all movies” for a particular location where the application may find all movie combinations meeting the user's parameters.

The user may then choose to pair a movie with the movie selected by the user or buy a ticket to the selected movie. In one instance, if all movies are being paired, then this step can be skipped.

Next, the application may ask for the user to select one or more parameters unless the user has previously set defaults for each parameter. Parameters may include, but are not limited to, by closest ending time, by closest beginning time, by closest combined ending and beginning times, by theaters near a user's location (e.g., distance may be defaulted to 10 theaters unless user sets a different default in settings), and/or by the user's preferred theater. If a user has already set defaults for each parameter, the application may request the user to confirm the set of parameters.

After the application has received inputs for each of the parameters (whether being confirmed for defaults or new selections) the application can determine which movies meet each of the defined parameters. The application may then present matched movies in an easy-to-understand format. In one instance, the movies may be presented beginning with the closest time match to a requested parameter then by distance between each matching pair of movies.

The user may then choose to purchase tickets and the application can set-up a purchase via a third-party application. For instance, Fandango, Movie Time, or Atom to name a few. Alternatively, the application may complete the purchase for the user. Additional options can then be provided to the user that integrates other applications that provide services (e.g. “Would you like an Uber or Lyft ride to/from the movies?”; “Would you like to pre-purchase food at your theater?”; “Would you like to purchase any movie swag?”).

In one embodiment, the application can be implemented to find movies that match an inputted start and/or end time provided by a user. For instance, a user may enter a start time that they would be able to make. The application may then perform an analysis on data received from an API service that calls a movie database to find all movies that start on or shortly after the inputted start time. In another instance, a user may enter a start time and an end time looking for a movie that starts and ends within a defined time frame. The application may then analyze the data received from the API service to find all movies that fit the criteria entered by the user. In yet another instance, the user may enter an end time from which they have other engagements that cannot be missed. The application may perform an analysis on the data received from the API service to find all movies that end by the inputted end time. As can be appreciated, the application may be implemented to match movies with a defined time frame from a user.

Use of the application by a plurality of users may provide information or data related to movies being paired together which can then be used to improve the business of showing movies to the public as paired movies. Data-to-decision transformations can include, but are not limited to, (i) movies which users attempt to pair together can intentionally be shown at times which allow such pairing, (ii) movies which users attempt to pair together can intentionally be advertised together, and (iii) movies which users attempt to pair together can intentionally be manipulated by a movie theater company to make them pair perfectly together.

In one example, if users of the application regularly attempt to pair a new “Star Wars” movie with a new “Finding Nemo” movie, then the movie theaters can present those two movies at times so that they end at roughly the same time, thereby increasing the probability that families wanting to watch those two movies at the same time will go to that theater. In another example, if a movie theater chain knows tweens (e.g., approximately 9-12 year olds) and their parents would be willing to see the new “Star Wars” movie and the new “Finding Nemo” movie if they were offered in a manner that facilitated such a pairing, then the theater (or movie production company) can advertise the pairing of those movies (e.g., they are being offered as a pair or that they end at the same time). More simply, the theater or production companies can advertise the two movies together generally with the intention of encouraging a further association they know from pairing data is already likely. In yet another example, movies which users attempt to pair together can intentionally be manipulated by a movie theater company to make them pair perfectly together. For instance, if a new “Star Wars” movie is twenty minutes longer than a new “Finding Nemo” movie, then the theater can add twenty additional minutes of previews, advertising, and/or post-credit content to the “Finding Nemo” movie so that the movie may be advertised to start at the same time as the “Star Wars” movie and end at approximately the same time. Currently, advertised start times are when previews begin and not when the movie starts.

In one embodiment, data obtained from movie theater chains and/or movie production companies can be used to improve an accuracy of the application pairing algorithm and user experience. For instance, improving accuracy can include (i) how long previews are before each movie, and (ii) whether there are “shorts” (e.g., short skits, cartoons or post-credit scenes) included in the movie, and the length of such added content which will add to the advertised length of the movie.

In some embodiments, the application can offer ride sharing services to and from the theater locations. Knowing when the paired movies will be over allows the user to order a ride to the movie and a ride from the movie at the same time. If the users order paired movies from two different theater locations, the application can coordinate rides to and from both locations for such a pairing.

In some embodiments, users can provide feedback regarding the convenience of the pairing they ordered. For instance, they may provide feedback regarding whether the pairing worked as they had hoped or did one movie unexpectedly run longer than expected. Such feedback can feed into the algorithm (if users rate the paring as terrible, then the algorithm discounts that pairing accordingly) as well as be provided overtly to users (e.g., “Users rated the pairing you are considering as excellent.”).

In some embodiments, users can communicate information about a movie to other users using the application. For instance, users may provide information related to whether the end credit scene is worth waiting for or even if there is a post-credit scene at all. In another example, users can provide whether the website Rotten Tomatoes has panned one of the proposed movies, etc. As can be appreciated, the application can be implemented as a movie and user-friend-fan specific blog.

Embodiments of the application can include a group function wherein friends and family can be linked together to receive information from other users linked to the group regarding movie pairings and information about movies. For instance, users in a group can propose one or more movie pairings to each other and “vote/like” such proposals while making plans for movie-going. As can be appreciated, such votes can be communicated to friends and/or family for final decisions/purchases regarding movies.

Common pairings adopted by users of the application can be proposed to other users in the same area or where the algorithm recognizes such pairing also exist within reasonable parameters. For example, in Atlanta, Ga. users may be pairing the “Star Wars” movie with the “Finding Nemo” movie in theaters where they start within 15 minutes of each other. The application may determine that in theaters in Denver, Colo. have similar start times, so the application suggests such pairings to application users in both Atlanta and Denver.

The application can allow users to create groups of friends and/or family for the purpose of facilitating electronically proposed movie pairings and obtaining agreement using a like/vote system as previously described. For instance, the application may propose a pairing of the “Star Wars” movie and the “Finding Nemo” movie. If the application user has already created a “Family” group (e.g., Mom, Dad, Uncle Bob, older sibling and younger sibling), the application can allow the user to “Send Proposed Pairing” to that group in a single tap and obtain “like/vote” feedback from that group for final movie purchase decision making.

Of significant note, data generated from use of the application has value and can be used and/or sold by and to movie production companies, entertainment companies, and theaters chains for various purposes. For instance, the application can offer movie specific advertising and pairing suggestions to users based on their movie decision making and pairing history. In one example, if a movie production company is coming out with a new action movie, it can purchase advertising directed to specific application users who have previously shown an affinity for action movies.

In another instance, theaters and movie production companies can use historical movie pairing data from the application to intentionally create and pair new, but similar movies, they know from that historical data movie-goers will more likely pair together. Such a strategy would use the same movie pairing advertising, length modifications, and presentation tactics as previously discussed.

In yet another instance, movie production companies and theaters may also find the pairing choices and considerations by the users of the application to be valuable for a host of other reasons. Such data streams can be collected and sold to movie production companies, entertainment companies, and theater companies generally.

The present invention can be embodied as devices, systems, methods, and/or computer program products. Accordingly, the present invention can be embodied in hardware and/or in software (including firmware, resident software, micro-code, etc.). Furthermore, the present invention can take the form of a computer program product on a computer-usable or computer-readable storage medium having computer-usable or computer-readable program code embodied in the medium for use by or in connection with an instruction execution system. In one embodiment, the present invention can be embodied as non-transitory computer-readable media. In the context of this document, a computer-usable or computer-readable medium can include, but is not limited to, any medium that can contain, store, communicate, propagate, or transport the program for use by or in connection with the instruction execution system, apparatus, or device.

The computer-usable or computer-readable medium can be, but is not limited to, an electronic, magnetic, optical, electromagnetic, infrared, or semiconductor system, apparatus, device, or propagation medium.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “software,” as used in this specification and the appended claims, refers to programs, procedures, rules, instructions, and any associated documentation pertaining to the operation of a system.

The term “firmware,” as used in this specification and the appended claims, refers to computer programs, procedures, rules, instructions, and any associated documentation contained permanently in a hardware device and can also be flashware.

The term “hardware,” as used in this specification and the appended claims, refers to the physical, electrical, and mechanical parts of a system.

The terms “computer-usable medium” or “computer-readable medium,” as used in this specification and the appended claims, refers to any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

The term “signal,” as used in this specification and the appended claims, refers to a signal that has one or more of its characteristics set or changed in such a manner as to encode information in the signal. It is to be appreciated that wireless means of sending signals can be implemented including, but not limited to, Bluetooth, Wi-Fi, acoustic, RF, infrared and other wireless means.

### An Embodiment of a Movie Matching System

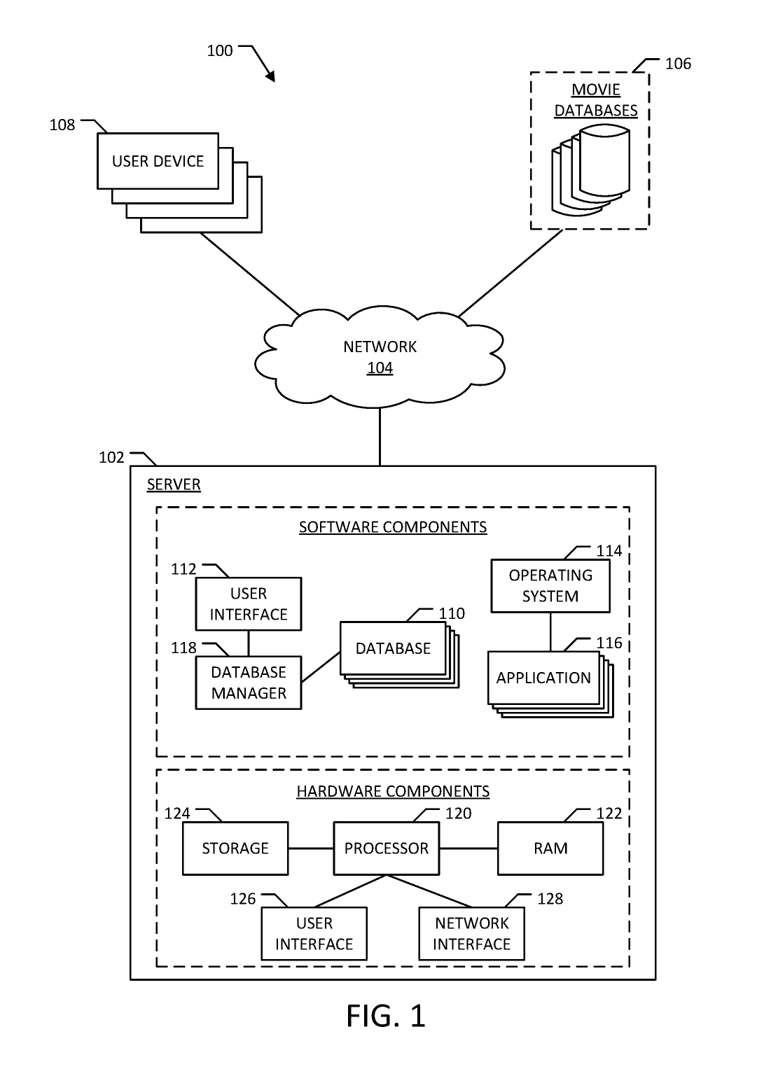

Referring to FIG. 1, a block diagram of an embodiment 100 of a movie matching system is illustrated. The movie matching system 100 can be implemented to determine and provide a graphical display of two or more movies that start and/or end within a predetermined time frame. The system 100 can be provide a means for purchasing tickets to the paired movies selected by a user.

In one embodiment, the movie matching system can include a server 102, a network 104, one or more movie databases 106, and one or more user devices 108.

Generally, data related to one or more users can be stored in the server 102. For instance, the data can be stored in one or more databases 110 of the server. It is to be appreciated that the data may be stored externally to the server 102. For instance, the databases may be remotely located from the server 102. Typically, a user can input information into an application on a user device 108 that can then be transferred to and stored in the databases 110. Typically, a unique identifier and relevant movie information can be stored for each user in the server 102.

The server 102 can represent a server or another powerful, dedicated computer system that can support multiple user sessions. In some embodiments, the server 102 can be any type of computing device including, but not limited to, a personal computer, a game console, a smartphone, a tablet, a netbook computer, or other computing devices. In one embodiment, the server can be a distributed system wherein server functions are distributed over several computers connected to a network. The server 102 can typically include a hardware platform and software components. As noted previously, the user devices 108 may be implemented as the server.

The software components of the server 102 can include the one or more databases 110 which can store user information and data. The software components can also include an operating system 114 on which various applications can execute. In one embodiment, the server 102 can include an application 116 dedicated to determining time differences between two movies. For instance, the application 116 can follow a process or method similar to the method described hereinafter. A database manager 118 can be an application that runs queries against the databases 110. In one embodiment, the database manager 118 can allow interaction with the databases through an HTML user interface on a user device.

The hardware platform of the server 102 can include, but is not limited to, a processor 120, random access memory 122, and nonvolatile storage 124. The processor 120 can be a single microprocessor, multi-core processor, or a group of processors. The random access memory 122 can store executable code as well as data that can be immediately accessible to the processor 120. The nonvolatile storage 124 can store executable code and data in a persistent state.

The hardware platform can include a user interface 126. The user interface 126 can include keyboards, monitors, pointing devices, and other user interface components. The hardware platform can also include a network interface 128. The network interface 128 can include, but is not limited to, hardwired and wireless interfaces through which the server 102 can communicate with other devices including, but not limited to, the movie databases 106 and the user devices 108.

The network 104 can be any type of network, such as a local area network, wide area network, or the Internet. In some cases, the network 104 can include wired or wireless connections and may transmit and receive information using various protocols.

The one or more movie databases 106 can include databases that provide information related to movie start times, end times, and locations of said movies that is available to the public. For instance, a movie database provided by Gracenote may be implemented. Typically, the plurality of movie databases 106 can store at least movie start time data and information accessible by the server 102 and, in some instances, the user devices 108.

The one or more user devices 108 can be any type of computing device on which a browser or mobile application can operate. Examples of such devices can include, but are not limited to, smart devices, desktop computers, laptop computers, tablet computers, mobile telephones, smart phones, game consoles, network appliances, or any other web-enabled devices. In an embodiment, the user devices 108 can have various hardware platforms on which a browser can execute. The browser can be used to access the HTML user interface of the database manager. In one instance, the system can execute functional operations by virtue of service calls to a service-based processing system.

In one embodiment, the movie matching system 100 can include an application or program adapted to transfer information and data between the user device 108 and the server 102 via the network 104. As can be appreciated, the application can be implemented to provide a graphical interface on the user device 108 to allow the user to input information and data. The application can then send the inputted data to the server 102. The server 102 can send or push notifications to the user device 108 and the application can be configured to provide a graphical display of the notification on the user device 108.

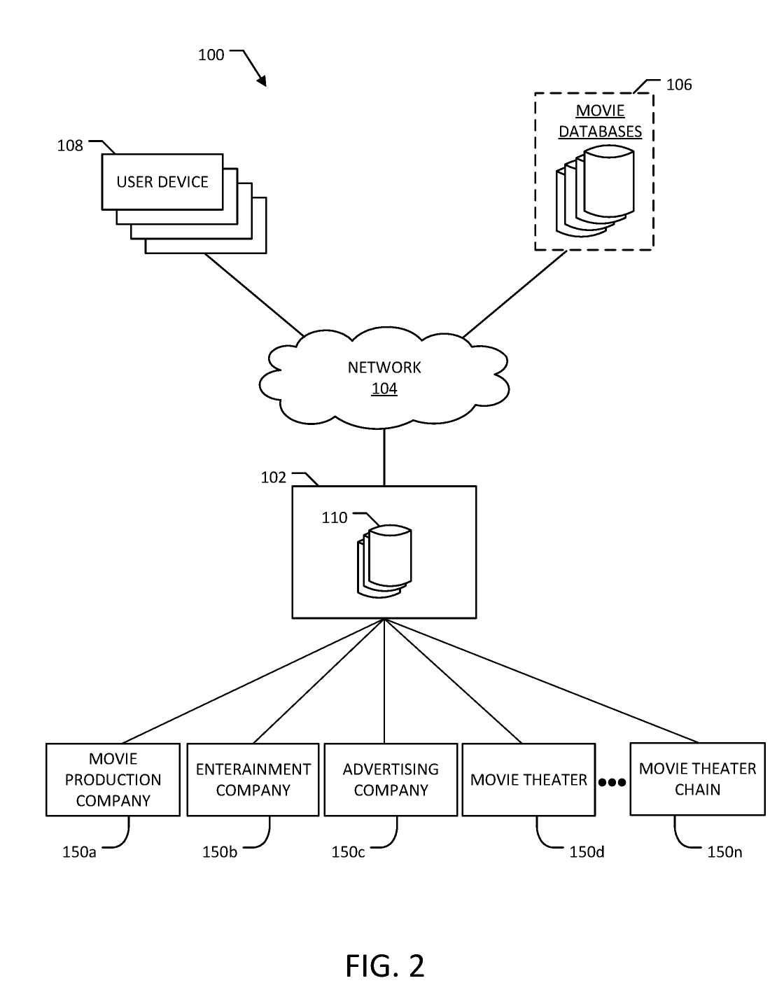

Referring to FIG. 2, a block diagram of the movie matching system 100 connected to one or more data consumers 150a-150n is illustrated. The one or more data consumers 150a-150n can be provided various forms of data related to movies being paired and tickets purchased for. The data consumers may include, but are not limited to, a movie production company 150a, an entertainment company 150b, an advertising company 150c, a movie theater 150d, and a movie theater chain 150n. Typically, the server 102 can store data received from the user devices 108 when the user devices 108 are running the application. The data consumers 150a-150n can access the data received from the application of a plurality of users.

A method (or process) for determining at least two movies having a start and/or end time within a prescribed time frame and within a defined geographical location is described hereinafter. Typically, the previously described system 100 can be implemented in conjunction with the hereinafter described method.

In a first step, a user can enter into the application on the user device 108 a geographical location and a selection for a first movie. In one instance, the application can provide a list of theaters for the user to select from within a geographical location. In some embodiments, the user device 108 being used by the user can automatically provide a current geographic location of the user to the application. Typically, the user can first input a movie that they would like to see along with a geographical location for determining the closet theaters to that location showing the movie. As mentioned previously, the user may select a theater presented by the application. As can be appreciated, the geographical location can be implemented to narrow the number of theaters showing the requested movie. In some instances, the user may broaden a scope of the geographical location if desired results are not obtained.

In a second step, the application can call an API service to receive data related to all movies being shown within the prescribed location and/or theaters selected.

In a third step, the user can define one or more parameters in the application to further refine a list of movies presented by the application. For instance, the user may define a time frame for a time difference between a start of movies and an end of movies. For example, the user may define a time difference of 10 minutes or less as a parameter.

In a fourth step, after the parameters have been defined and data has been received from the API service, the application can start to analyze the movie data and determine which pairs of movies meet the parameters set by the user (or possibly default parameters). In one embodiment, the application can compare a start time and an end time for the selected movie and every movie included in the data from the API service call. The application can then discard any movie combinations where a difference between the start times and/or end times is more than the prescribed amount of time. In some instances, the application may use a default time of 15 minutes as an allowed difference between start times and between end times.

Once the application has determined which pairs of movies meet said requirements, the application can present a listing of pairs of movies including at least a title of the movies, run times of the movies, difference between start times of said movies, difference between end times of said movies, and a theater name where movies are being shown. In one embodiment, the application can prioritize the list of movies based on ratings by one or more movie rating sites to then present the best reviewed movies first. In another embodiment, the application can prioritize the list of movies based on a proximity in time of the movie start times.

As can be appreciated, the user device 108 being used by the user can display all of the results on the display of the user device 108. In some embodiments, the application can provide actionable items for a user to access other third-party applications that provide other services. For instance, the application may provide an actionable link to a car service provider that may provide a ride to the movie theater or between theaters.

In one example embodiment, the method can include, but is not limited to, the following steps. First, an application can be provided on a user device. The application can have an interface for inputting data. Next, a user can input a desired start time and a a geographical location. Once the user has input the desired start time and the geographical location, the user can select a primary movie. Once the user has inputted the initial parameters, the application can determine if the primary movie (i) has a first start time within a predetermined limit of the inputted start time, and (i) is being shown at a movie theater within a predetermined limit of the inputted geographical location. Next, the application can determine a plurality of movies to present to the user based on the inputted information of the user and the primary movie and then present a first movie from the plurality of movies to the user. The user may then select a secondary movie from the plurality of movies. After the user has selected a primary movie and secondary movie to pair, the application can provide a link for the user to purchase tickets for the primary movie and the secondary movie. If the user would like to purchase tickets for the paired movies, the user can follow the link to purchase tickets for the primary movie and the secondary movie. When the user follows the link, the application can send data to a database where the data may be related to the primary movie and the secondary movie. The data related to the primary movie and the secondary movie received from the application can be stored. The data sent by the application can include, but is not limited to, movie titles for the primary movie and the secondary movie, a start time of the primary movie and the secondary movie, an end time of the primary movie and the secondary movie, a difference in end times between the primary movie and the secondary movie, and a difference in start times between the primary movie and the secondary movie.

In one embodiment, the step of determining a plurality of movies to present to the user based on the inputted information of the user can include, but is not limited to, the following steps. First, a data request can be sent to a movie database via an application programming interface. The data request can include, but is not limited to, a list of movies being shown in each movie theater within a predetermined distance from the geographical location inputted by the user. Next, a first set of movies can be determined having a start time within a predetermined limit of the first start time of the primary movie. A second set of movies can be determined having an end time within a predetermined limit of a first end time of the primary movie. Then, a third set of movies can be determined that each have (i) a start time within the predetermined limit of the first start time of the primary movie, and (ii) an end time within the predetermined limit of the first end time of the primary movie. Of note, movies from the list of movies that do not have a start time within the predetermined limit of the first start time of the primary movie and an end time within the predetermined limit of the first end time of the primary movie can be deleted. Finally, the first set of movies, the second set of movies, and the third set of movies can be combined as the plurality of movies to be presented to the user.

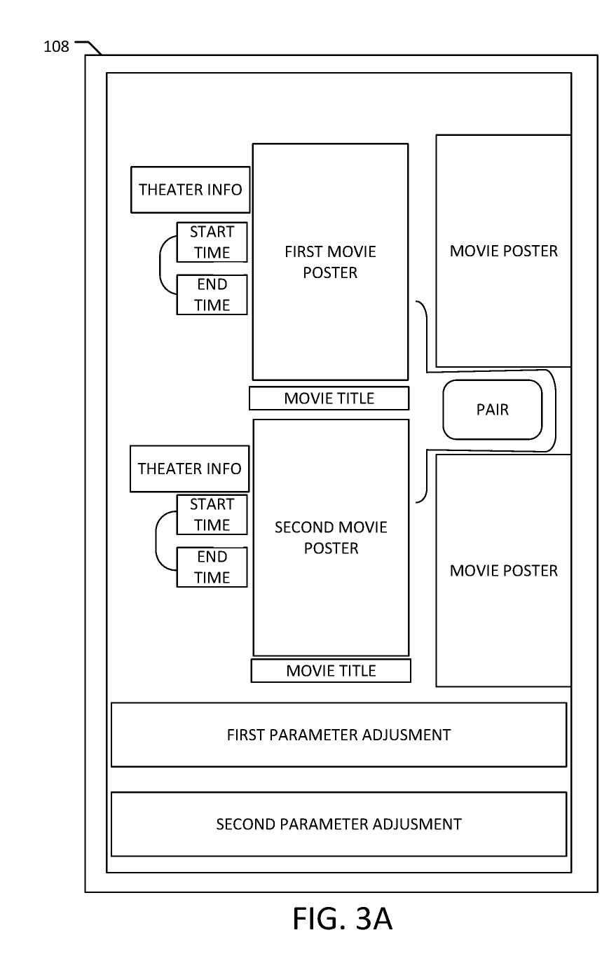

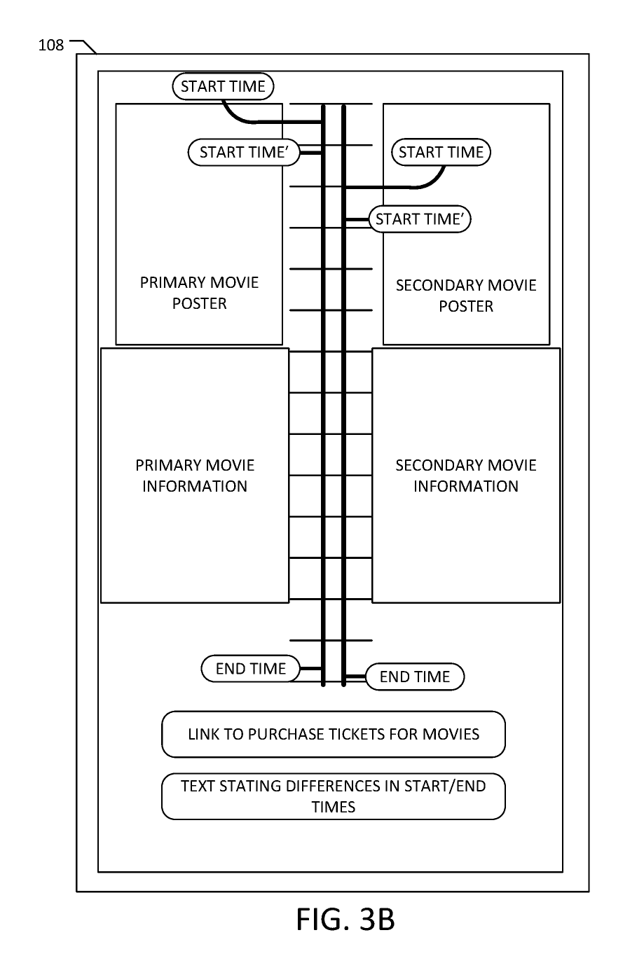

Referring to FIGS. 3A-3B, detailed diagrams of example user interfaces of the application on a user device 108 are illustrated. A screenshot of the example user interfaces are included in Appendix A to the specification.

Referring to FIG. 3A, a user interface for selecting movies to pair together is illustrated. As shown, the application can present a “first movie poster” graphical display and a “SECOND MOVIE POSTER” graphical display for movies matching inputted parameters from a user. The interface can include a “PAIR” actionable icon for pairing the movies indicated by the “FIRST MOVIE POSTER” and the “SECOND MOVIE POSTER”. The “MOVIE POSTER” graphical displays located next to the “FIRST MOVIE POSTER” and the “SECOND MOVIE POSTER” can display movies that meet the parameters inputted by the user. For instance, the “MOVIE POSTER” graphical display located next to the “SECOND MOVIE POSTER” graphical display may be another movie that matches the parameters input by a user. To cycle through the movies that match with the primary movie, the user may slide the “MOVIE POSTER” graphical display over to the “SECOND MOVIE POSTER” graphical display location and the next movie that matches with the primary movie may populate in the “MOVIE POSTER” graphical display location. Of note, other means for cycling through the movies are contemplated and not outside the scope of the present invention.

Typically, the movie which the user selected as a primary movie may be displayed in the “FIRST MOVIE POSTER” graphical display. A first movie of a plurality of movies matching the parameters inputted by the user may be shown in the “SECOND MOVIE POSTER” graphical display. In one example, the selection of the secondary movie may include sliding the “MOVIE POSTER” graphical display over to where the “SECOND MOVIE POSTER” graphical display is located. This will update the information related to the “SECOND MOVIE POSTER” with the information for the movie that was previously in the “MOVIE POSTER” graphical display. As can be appreciated, the user may slide through one or more movies depending on how many movies meet the parameters inputted by the user. In some instances, the user may change the primary movie by sliding the “MOVIE POSTER” graphical display located next to the “FIRST MOVIE POSTER” graphical display over to the “FIRST MOVIE POSTER” graphical display location. When the user changes the primary movie, the secondary movie choices can be updated accordingly.

Information related to where the movies are being played, start times, and end times can be provided as graphical displays to the user. The interface can further include actionable icons or buttons for adjusting a first parameter and a second parameter. For instance, a “FIRST PARAMETER ADJUSTMENT” graphical display and a “SECOND PARAMETER ADJUSTMENT” graphical display can be implemented. Of note, in some embodiments, the user may determine which parameters are presented as actionable icons when pairing movies. In one example, the first parameter may be for a start time and the second parameter may be for a distance from a location of the user. As can be appreciated, the user may interact with the actionable icons to change the parameters.

Once the user has found a primary movie and a secondary movie to pair, the user may select the “PAIR” actionable button and be taken to the interface shown in FIG. 3B.

Referring to FIG. 3B, a user interface for reviewing information related to paired movies before purchasing tickets for the paired movies is illustrated. The interface may include a graphical display of a time line for start times and end times of the paired movies. In one instance, as shown, the interface may include a “START TIME” graphical display indicating the stated start time and a “START TIME” graphical display indicating when the movie will actually begin (e.g., after previews are done). The interface may further include a “PRIMARY MOVIE POSTER” graphical display and a “SECONDARY MOVIE POSTER” graphical display and information related to each movie below the movie posters. The timeline may show a graphical representation of differences between start times and end times of the movies. The user interface may further include an actionable button or icon “LINK TO PURCHASE TICKETS FOR MOVIES” where the user may be taken to a website to purchase tickets for the paired movies. A “TEXT STATING DIFFERENCES IN START/END TIMES” graphical display can include text stating the differences between the start times and end times of the primary movie and the secondary movie. Of note, when the user selects the purchase tickets actionable icon, data related to the primary movie and the secondary movie can be sent to the server 102 or another database.

### ALTERNATIVE EMBODIMENTS AND VARIATIONS

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

### APPENDICES

Appendix A includes screenshots of a user interface of the previously described application. Page 1 includes a screenshot of a user interface for picking movies to pair together. The screenshot on page 1 is similar to the previously described user interface of FIG. 3A. Page 2 includes a screenshot of a user interface that displays information about the paired movies and includes a link to purchase tickets for the paired movies. The screenshot on page 2 is similar to the previously described user interface of FIG. 3B.

I claim:

1. A method for obtaining information related to movies a plurality of users are buying tickets for, the method comprising:
providing an application on a user device, the application having an interface for inputting data;
by a user, inputting a start time;
by the user, inputting a geographical location;
by the user, inputting a selection for a primary movie;
by the application, determining if the primary movie (i) has a first start time within a predetermined limit of the inputted start time, and (i) is being shown at a movie theater within a predetermined limit of the inputted geographical location;
by the application, determining a plurality of movies to present to the user based on the inputted information of the user;
by the application, presenting a first movie from the plurality of movies to the user;
by the user, selecting a secondary movie from the plurality of movies;
by the application, providing a link for the user to purchase tickets for the primary movie and the secondary movie;
by the user, following the link to purchase tickets for the primary movie and the secondary movie; and
by the application, sending data to a database, the data being related to the primary movie and the secondary movie when the user follows the link to purchase tickets;
wherein the data sent by the application includes movie titles for the primary movie and the secondary movie, a start time of the primary movie and the secondary movie, an end time of the primary movie and the secondary movie, a difference in end times between the primary movie and the secondary movie, and a difference in start times between the primary movie and the secondary movie.

2. The method of claim 1, wherein the step of determining a plurality of movies to present to the user based on the inputted information of the user includes:
sending a data request to a movie database via an application programming interface, the data request including:
a list of movies being shown in each movie theater within a predetermined distance from the geographical location inputted by the user;
determining a first set of movies having a start time within a predetermined limit of the first start time of the primary movie;
determining a second set of movies having an end time within a predetermined limit of a first end time of the primary movie;
determining a third set of movies that each have (i) a start time within the predetermined limit of the first start time of the primary movie, and (ii) an end time within the predetermined limit of the first end time of the primary movie;
deleting movies from the list of movies that do not have a start time within the predetermined limit of the first start time of the primary movie and an end time within the predetermined limit of the first end time of the primary movie; and
combining the first set of movies, the second set of movies, and the third set of movies as the plurality of movies to be presented to the user.

3. The method of claim 2, the method further including the steps of:
by the user, inputting a selection to prioritize the plurality of movies based on start time, end time, or start time and end time.

4. The method of claim 1, the method further including the step of:
storing the data related to the primary movie and the secondary movie received from the application.

5. The method of claim 1, the method further including the steps of:
by the application, generating a graphical display of a difference between the start times and end times of the primary movie and each movie of the plurality of movies; and
by the application, displaying the graphical display for the primary movie and a first movie of the plurality of movies.

6. The method of claim 1, the method further comprising the step of:
by the user, selecting another movie as a new primary movie.

7. The method of claim 6, the method further comprising the steps of:
by the application, determining a second plurality of movies to present to the user based on the new primary movie and the previously inputted information from the user;
by the application, presenting one or more movies from the second plurality of movies to the user;
by the user, selecting a new secondary movie from the second plurality of movies;
by the application, providing a link for the user to purchase tickets for the new primary movie and the new secondary movie.

8. A method for obtaining data related to pairs of movies that tickets are being bought for concurrently, the method comprising:
providing an application on a plurality of user devices, the application having an interface for inputting data; and
receiving paired movie data from the application each time the application is run on a user device and a user follows a link to purchase tickets for a primary movie and a secondary movie paired together in the application;
wherein the paired movie data sent by the application includes movie titles for the primary movie and the secondary movie, a start time of the primary movie and the secondary movie, an end time of the primary movie and the secondary movie, a difference in end times between the primary movie and the secondary movie, and a difference in start times between the primary movie and the secondary movie.

9. The method of claim 8, wherein the application generates the paired movie data based on input from a user.

10. The method of claim 9, wherein the paired movie data is generated by the following steps:
receiving input for a start time;
receiving input for a geographical location;
receiving input for a selection of a primary movie;
determining if the primary movie (i) has a first start time within a predetermined limit of the inputted start time, and (i) is being shown at a movie theater within a predetermined limit of the inputted geographical location;
determining a plurality of movies to present based on the inputted information;
presenting a first movie from the plurality of movies to the user;
receiving a selection for a secondary movie from the plurality of movies;
providing a link for the user to purchase tickets for the primary movie and the secondary movie;
detecting that the user followed the link to purchase tickets for the primary movie and the secondary movie;
storing information related to the primary movie and the secondary movie including a start time and an end time for each movie.

11. The method of claim 8, wherein a movie theater showing the primary movie and the secondary movie change a start time of the movies based on the paired movie data.

12. The method of claim 8, wherein a movie theater changes future start times of the primary movie and the secondary movie based on the paired movie data.

13. The method of claim 8, wherein the application generates a graphical display of a timeline showing a start time and an end time of the primary movie and the secondary movie.

14. The method of claim 8, wherein the application includes an actionable icon on the user interface to pair movies together.

15. The method of claim 14, wherein the application generates a link to purchase tickets to the primary movie and the secondary movie when the user activates the actionable icon to pair the movies together

16. A movie matching system comprising:
at least one processor;
at least one computer-readable storage media having stored thereon computer-executable instructions that, when executed by the at least one processor, causes the system to perform a method, the method comprising the following:
receiving input for a start time;
receiving input for a geographical location;
receiving input for a selection of a primary movie;
determining if the primary movie (i) has a first start time within a predetermined limit of the inputted start time, and (i) is being shown at a movie theater within a predetermined limit of the inputted geographical location;
determining a plurality of movies to present based on the inputted information;
presenting a first movie from the plurality of movies to the user;
receiving a selection for a secondary movie from the plurality of movies;
providing a link for the user to purchase tickets for the primary movie and the secondary movie;
detecting that the user followed the link to purchase tickets for the primary movie and the secondary movie;
sending paired movie data to a database, the paired movie data being related to the primary movie and the secondary movie when the user follows the link to purchase tickets;
wherein the paired movie data sent by the application includes movie titles for the primary movie and the secondary movie, a start time of the primary movie and the secondary movie, an end time of the primary movie and the secondary movie, a difference in end times between the primary movie and the secondary movie, and a difference in start times between the primary movie and the secondary movie.

17. The system of claim 16, wherein the database is accessible by one or more third party data consumers.

18. The system of claim 17, wherein the one or more third party data consumers include:
a movie production company;
an entertainment company;
an advertising company;
a movie theater; and
a movie theater chain.

20. The system of claim 16, wherein the plurality of movies are prioritized for presentation based on start time, end time, or start time and end time
